(19) United States
(12) Patent Application Publication
(10) Pub. No.: US 2011/0017152 A1
(43) Pub. Date: Jan. 27, 2011

(54) BOILER FOR SUPPLYING HEATING WATER AND HOT WATER SIMULTANEOUSLY

(75) Inventor: Tae-sik Min, Seoul (KR)

Correspondence Address: LEYDIG VOIT & MAYER, LTD, 700 THIRTEENTH ST. NW, SUITE 300, WASHINGTON, DC, 20005-3960, US

(73) Assignee: KYUNGDONG NAVIEN CO., LTD., Gyeonggi-do (KR)

(21) Appl. No.: 12/934,086

(22) PCT Filed: Jan. 5, 2009
(86) PCT No.: PCT/KR2009/000024

§ 371 Date: Oct. 14, 2010

(30) Foreign Application Priority Data
Mar. 27, 2008 (KR) 2008-0028225

(51) Int. Cl. F24H 9/00; G05D 23/13

(52) U.S. Cl. 122/19.1; 236/12.15

(57) ABSTRACT

A boiler capable of simultaneously performing a heating operation and a hot water operation and readily controlling the temperature of the hot water. In the boiler primary heating water is heated by a burner in a main heat exchanger and is supplied to a place in need of heating to be used as heating water. Secondary heating water exchanges heat with the primary heating water in an instant heat exchanger and is supplied to a place in need of hot water to be used as hot water. The boiler includes a flow regulator so that the primary heating water is supplied to the place in need of heating after flowing through the flow regulator which regulates flow depending on heating load, and is subsequently supplied to the instant heat exchanger after regulation by the flow regulator depending on hot water load.

### TECHNICAL FIELD

The present invention relates to a boiler capable of simultaneously supplying heating water and hot water, and more particularly, to a boiler capable of simultaneously performing a heating operation and a hot water operation and readily controlling the temperature of the hot water.

### BACKGROUND ART

Generally, domestic boilers are classified into an instant gas boiler that can quickly heat water upon operation of the boiler using a heat exchanger, and a hot-water tank gas boiler that can store hot water in a tank to supply the hot water depending on necessity.

FIG. 1 is a schematic view of a conventional instant gas boiler.

Water forcedly supplied by a circulation pump 10 is heated through a main heat exchanger 11. The heated water may be supplied to a place in need of heating through a heating water supply pipe 15, or may be supplied to an instant heat exchanger 14 to heat cold water and supply hot water, depending on a position of a three-way valve 13.

That is, when the three-way valve 13 opens the heating water supply pipe 15 and closes the instant heat exchanger 14, the heating water is supplied to the place in need of heating through the heating water supply pipe 15 to provide heating.

In addition, when the three-way valve 13 closes the heating water supply pipe 15 and opens the instant heat exchanger 14, the heating water is supplied toward the instant heat exchanger 14 to quickly heat the water.

However, since the conventional instant gas boiler cannot simultaneously perform a heating operation and a hot water operation, it is difficult to appropriately heat a room while hot water is used.

In FIG. 1, reference numeral 12 designates a burner, reference numeral 16 designates a heating water return pipe, and reference numeral 17 designates an expansion tank.

FIG. 2 is a schematic view of a conventional hot-water tank gas boiler.

Water stored in an inner space 21a of a tank 21 is heated by a burner 24 and then forcedly supplied by a pump 23 to a place in need of heating. Cold water introduced into a coil in the tank 21 is heat-exchanged with the heated water in the inner space 21a to be supplied as hot water.

While the above-mentioned hot-water tank gas boiler can simultaneously perform the heating operation and the hot water operation, it is difficult to accurately adjust the temperature of the hot water.

### SUMMARY OF THE INVENTION

In order to solve the foregoing and/or other problems, it is an object of the present invention to provide a boiler capable of simultaneously performing a heating operation and a hot water operation and readily controlling the temperature of the hot water.

One aspect of the present invention provides a boiler in which primary heating water heated by a burner in a main heat exchanger is supplied into a place in need of heating, to be used as heating water, and secondary heating water heat-exchanged with the primary heating water in an instant heat exchanger is supplied to a place in need of hot water, to be used as the hot water, characterized in that the primary heating water is supplied to the place in need of heating after regulating a flow rate of the heating water using a flow regulator depending on a heating load, and then supplied toward the instant heat exchanger after regulating the flow rate depending on a hot water load.

In this case, the flow regulator may be a mixing valve including an inlet through which the primary heating water is introduced, a first outlet for supplying the introduced primary heating water into the place in need of heating, a second outlet for supplying the introduced primary heating water toward the instant heat exchanger, and a flow regulating member for regulating a flow rate of the heating water supplied through the first outlet and the second outlet.

In addition, the flow regulator may include a first proportional flow control valve for controlling a flow rate of the primary heating water supplied to the place in need of heating, and a second proportional flow control valve for controlling a flow rate of the primary heating water supplied toward the instant heat exchanger.

Further, the instant heat exchanger may be installed separately from the main heat exchanger.

Furthermore, the main heat exchanger may be a hot-water tank type formed in a cylindrical structure in which a certain amount of water is contained, or an instant heating type for heating water while the water passes through a heat exchange pipe.

According to the present invention, since a heating operation and a hot water operation can be simultaneously performed, the heating operation can be normally performed even when the hot water is used. In addition, a flow rate of the hot water is controlled depending on a hot water load, and the temperature of the hot water can be controlled.

### BRIEF DESCRIPTION OF DRAWING FIGURES

The above and other objects, features and advantages of the present invention will be more apparent from the following detailed description taken in conjunction with the accompanying drawings, in which:

FIG. 1 is a schematic view of a conventional instant gas boiler;

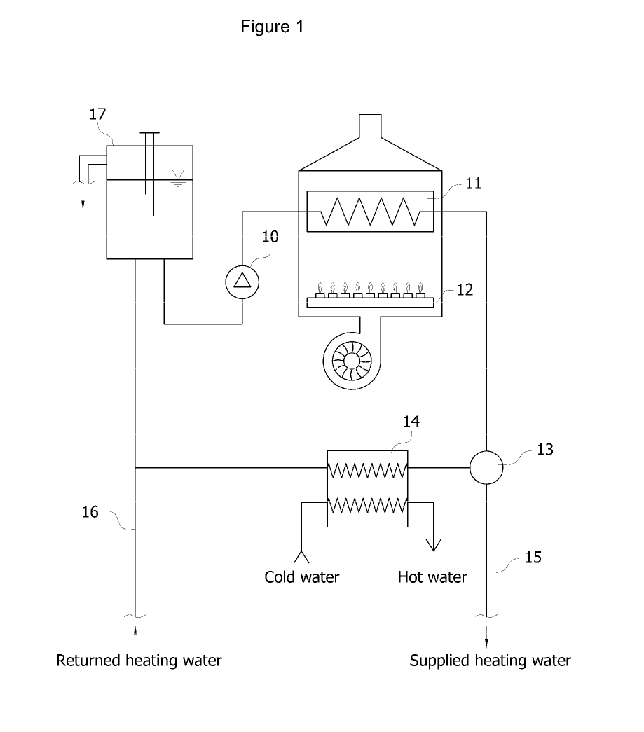

FIG. 2 is a schematic view of a conventional hot-water tank gas boiler;

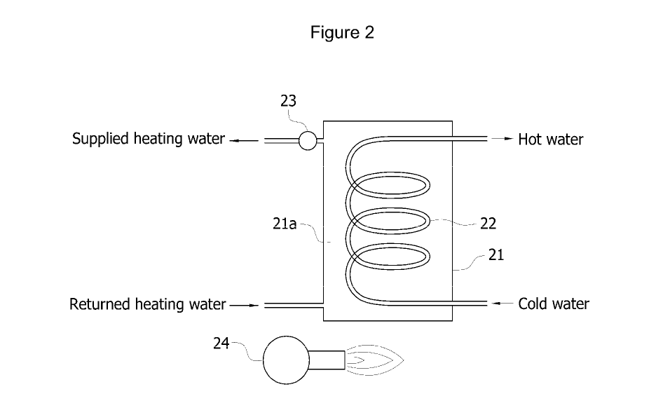

FIG. 3 is a schematic view of an instant gas boiler in accordance with an exemplary embodiment of the present invention;

FIGS. 4A to 4E are schematic views showing an operation theory of a conventional mixing valve;

FIGS. 5A to 5E are schematic views showing operation states of a mixing valve applied to the boiler of FIG. 3;

FIG. 6 is a schematic view of an instant gas boiler in accordance with another exemplary embodiment of the present invention;

FIG. 7 is a schematic view of a hot-water tank gas boiler in accordance with an exemplary embodiment of the present invention; and

FIG. 8 is a schematic view of a hot-water tank gas boiler in accordance with another exemplary embodiment of the present invention.

### DETAILED DESCRIPTION

Exemplary embodiments of the present invention will now be described in detail with reference to the accompanying drawings.

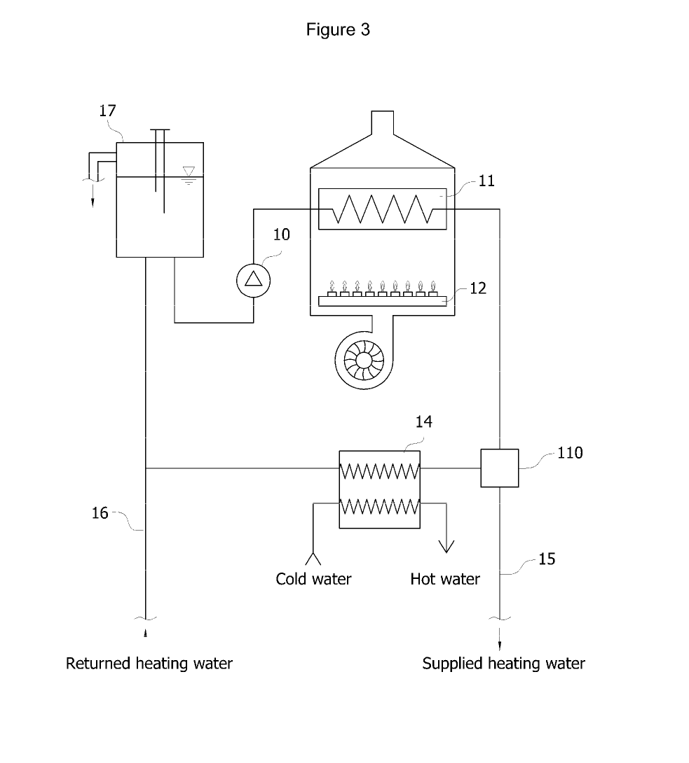

FIG. 3 is a schematic view of an instant gas boiler in accordance with an exemplary embodiment of the present invention.

The gas boiler in accordance with the present invention includes a circulation pump 10 for circulating heating water, a main heat exchanger 11 for heat-exchanging the heating water forcedly supplied by the circulation pump 10 with a combustion gas generated from a burner 12, an instant heat exchanger 14 for heating cold water to supply hot water when the hot water is used, a heating water supply pipe 15, a heating water return pipe 16, and an expansion tank 17, which are the same as in the conventional art.

The gas boiler in accordance with the present invention further includes a mixing valve 110 for supplying primary heating water heated by the main heat exchanger 11 to a place in need of heating through the heating water supply pipe 15 after regulating a flow rate of the primary heating water depending on a heating load, and supplying the primary heating water toward the instant heat exchanger 14 after regulating the flow rate of the primary heating water depending on a hot water load.

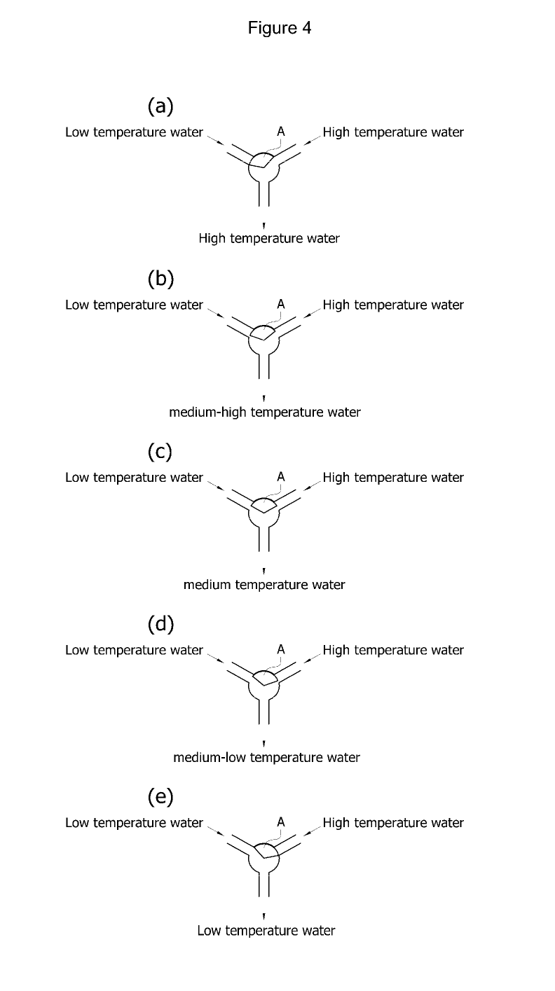

FIGS. 4A to 4E are schematic views showing an operation theory of a conventional mixing valve.

In general, the mixing valve refers to a valve that can regulate a mixed flow rate of high temperature water and low temperature water to control a temperature of water discharged therefrom.

As shown in FIGS. 4A to 4E, the mixing valve includes two inlets through which high temperature water and low temperature water are introduced, a flow regulating member A installed between the two inlets to adjust opening degrees of the two inlets, and an outlet for mixing the water mixed through the two inlets and discharging the mixed water.

In FIG. 4A, the flow regulating member A is positioned such that low temperature water is almost blocked and a large amount of high temperature water is introduced, and water discharged through the outlet becomes high temperature water. In FIG. 4B, a small amount of low temperature water is introduced, and water discharged through the outlet becomes medium-high temperature water. Similarly, in FIGS. 4C to 4E, by varying positions of the flow regulating member A, water discharged through the outlet becomes medium temperature water, medium-low temperature water, or low temperature water.

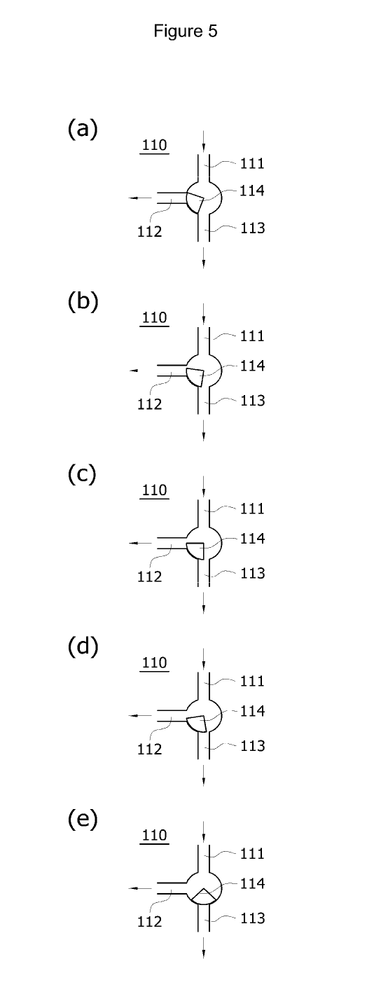

Hereinafter, application of the conventional mixing valve to the boiler in accordance with the present invention will be described with reference to FIGS. 5A to 5E.

FIGS. 5A to 5E are schematic views showing operation states of the mixing valve applied to the boiler of FIG. 3.

The mixing valve 110 in accordance with the present invention includes a single inlet 111 through which primary heating water heated by a main heat exchanger 11 is introduced, a first outlet 112 connected to a first heat exchanger 14 to discharge the primary heating water introduced through the inlet 111, a second outlet 113 connected to a heating water supply pipe 15 to discharge the primary heating water introduced through the inlet 111, and a flow regulating member 114 for adjusting opening degrees of the first outlet 112 and the second outlet 113.

Positions of the flow regulating member 114 are determined by signals of a controller (not shown) depending on a heating load and a hot water load.

FIG. 5A shows a case in which a hot water load is 0% and a heating load is 100%. The flow regulating member 114 completely closes the first outlet 112 to block the primary heating water toward the instant heat exchanger 14, and opens the second outlet 113 100% to supply the entire primary heating water to a place in need of heating through the inlet 111.

FIG. 5B shows a case in which a heating load is larger than a hot water load. The flow regulating member 114 slightly opens the first outlet 112 to perform a hot water operation with a small load, and simultaneously opens the second outlet 113 more widely than the first outlet 112 to perform a heating operation with a large load.

In addition, FIG. 5C shows a case in which a heating load is equal to a hot water load, FIG. 5D shows a case in which a hot water load is larger than a heating load, and FIG. 5E shows a case in which a hot water load is 100% and a heating load is 0%.

As described above, the mixing valve 110 enables simultaneous operation of the heating operation and the hot water operation, and flow regulation according to the heating load and the hot water load, so that temperature control of hot water can be readily performed.

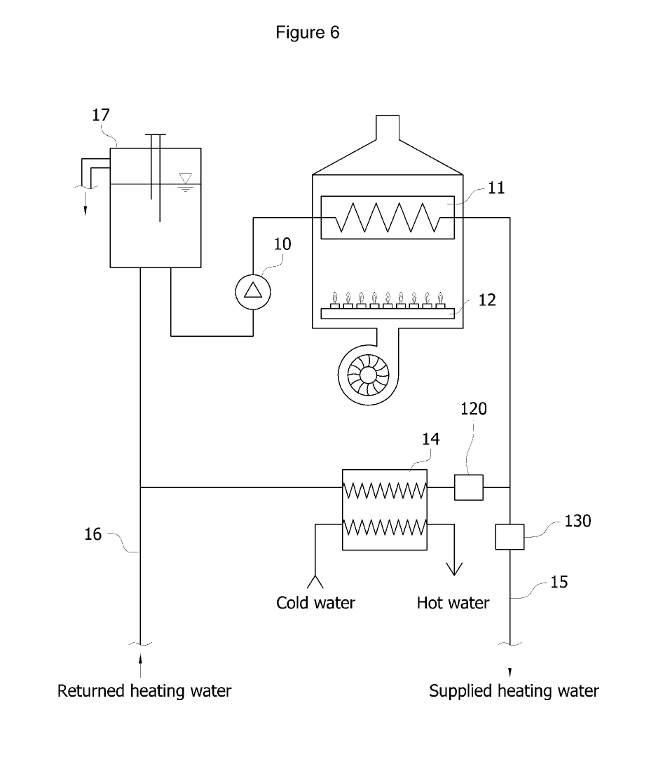

FIG. 6 is a schematic view of an instant gas boiler in accordance with another exemplary embodiment of the present invention.

In the embodiment of FIG. 6, a flow regulator includes a first proportional flow control valve 120 for supplying primary heating water heated by a main heat exchanger 11 toward an instant heat exchanger 14, and a second proportional flow control valve 130 for supplying the primary heating water toward a heating water supply pipe 15.

The first and second proportional flow control valves 120 and 130 control the flow rate of the primary heating water passing through the control valves 120 and 130 by adjusting opening degree of the valves using a controller (not shown) depending on a hot water load and a heating load.

Opening degrees of the proportional flow control valves depending on the hot water load and the heating load are as follows:

| | | Hot water load vs. Heating load | | | | |
|---|---|---|---|---|---|---|
| | | | Heating | Heating | | Heating |
| | | Heating | load < | load = | Heating | load |
| | | load 0%, | Hot | Hot | load > | 100%, |
| | | Hot water | water | water | Hot water | Hot |
| | | load 100% | load | load | load | load 0% |
| Opening | Opening | 100% | 50% or | 50% | 0% or | 0% |
| degrees | degree | | more, | | more, | |
| of | of first | | 100% or | | 50% or | |
| proport- | proporti- | | less | | less | |
| ional | onal | | | | | |
| control | control | | | | | |
| valves | valve | | | | | |
| | Opening | 0% | 50% or | 50% | 50% or | 100% |
| | degree | | less, | | more, | |
| | of | | 0% or | | 100% or | |
| | second | | more | | less | |
| | proporti- | | | | | |
| | onal | | | | | |
| | control | | | | | |
| | valve | | | | | |

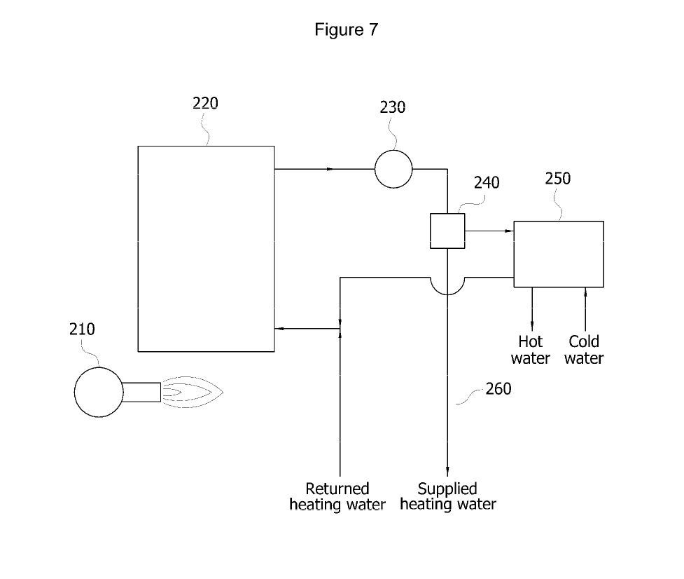

FIG. 7 is a schematic view of a hot-water tank gas boiler in accordance with an exemplary embodiment of the present invention.

The gas boiler of the embodiment includes a burner 210, a main heat exchanger 220 heat-exchanged with a combustion gas from the burner 210, a circulation pump 230 for forcedly supplying primary heating water heated by the main heat exchanger 220, and a mixing valve 240 for controlling a flow rate of the primary heating water forcedly supplied by the circulation pump 230 and supplying the primary heating water to a instant heat exchanger 250 or a heating pipe supply pipe 260 depending on a hot water load or a heating load.

The main heat exchanger 220 is formed of a cylindrical structure, in which a certain amount of water is contained, to constitute a hot-water tank boiler.

In the instant heat exchanger 250, the primary heating water supplied through the mixing valve 240 is heat-exchanged with cold water to supply secondary heating water to a place in need of hot water.

The mixing valve 240 has the same structure as the mixing valve of FIG. 5. Therefore, a flow rate of the primary heating water supplied to the instant heat exchanger 250 or the heating water supply pipe 260 can be adjusted depending on the heating load and the hot water load, and thus, a heating operation and a hot water operation can be simultaneously performed, and a temperature of the hot water can be readily controlled.

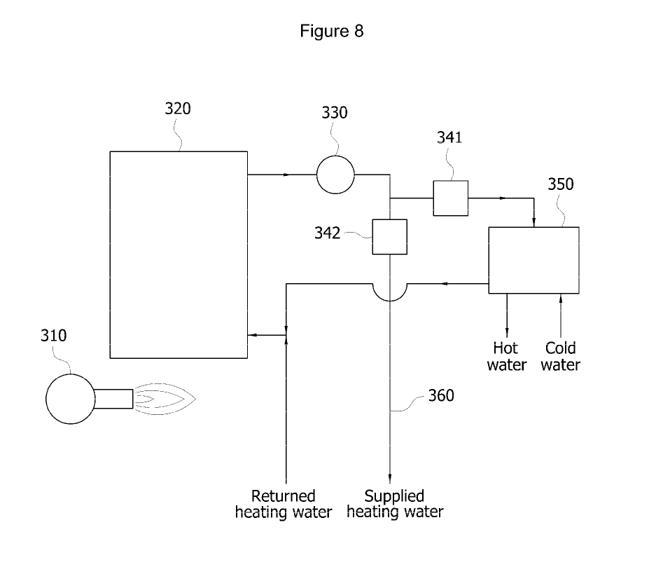

FIG. 8 is a schematic view of a hot-water tank gas boiler in accordance with another exemplary embodiment of the present invention.

While the gas boiler of the embodiment also includes a burner 310, a cylindrical main heat exchanger 320, a circulation pump 330, an instant heat exchanger 350, and a heating water supply pipe 360, which are the same as that of FIG. 7, the gas boiler of FIG. 8 is characterized in that a first proportional flow control valve 341 for controlling a flow rate of primary heating water supplied to an instant heat exchanger 350 and controlling a flow rate of the primary heating water supplied to the heating water supply pipe 360.

The first and second proportional flow control valves 341 and 342 perform the same functions as in the embodiment of FIG. 6 to vary opening degree of the valves depending on a heating load and a hot water load, thereby controlling a flow rate of the primary heating water.

While few exemplary embodiments of the present invention have been shown and described, it will be appreciated by those skilled in the art that various changes may be made to these embodiments without departing from the spirit and scope of the invention as defined by the appended claims and their equivalents.

### INDUSTRIAL APPLICABILITY

As can be seen from the foregoing, a boiler capable of simultaneously supplying heating water and hot water in accordance with the present invention can simultaneously perform a heating operation and a hot water operation and readily control the temperature of hot water.

1. A boiler comprising:
a main heat exchanger in which primary heating water is heated by a burner and is supplied to a place in need of heating, to be used as heating water;
an instant heat exchanger in which secondary heating water exchanges heat with the primary heating water and is supplied to a place in need of hot water, to be used as hot water; and
a flow regulator, wherein the primary heating water is supplied to the place in need of heating after the flow regulator regulates flow rate of the primary heating water depending on a heating load, and, subsequently, the primary heating water is supplied to the instant heat exchanger after the flow regulator regulates the flow rate depending on a hot water load.

2. The boiler according to claim 1, wherein the flow regulator includes a mixing valve having
an inlet through which the primary heating water is introduced,
a first outlet for supplying the primary heating water introduced through the inlet to the place in need of heating,
a second outlet for supplying the primary heating water introduced through the inlet to the instant heat exchanger, and
a flow regulating member for regulating flow rate of the heating water supplied through the first outlet and the second outlet.

3. The boiler according to claim 1, wherein the flow regulator comprises:
a first proportional flow control valve for controlling the flow rate of the primary heating water supplied to the place in need of heating, and
a second proportional flow control valve for controlling the flow rate of the primary heating water supplied to the instant heat exchanger.

4. The boiler according to claim 2, wherein the instant heat exchanger is located separately from the main heat exchanger.

5. The boiler according to claim 4, wherein the main heat exchanger is a hot-water tank having a cylindrical structure for containing water.

6. The boiler according to claim 4, wherein the main heat exchanger is an instant heating heat exchanger for heating water while the water passes through a heat exchange pipe.

7. The boiler according to claim 3, wherein the instant heat exchanger is located separately from the main heat exchanger.

8. The boiler according to claim 7, wherein the main heat exchanger is a hot-water tank having a cylindrical structure for containing water.

9. The boiler according to claim 7, wherein the main heat exchanger is an instant heating heat exchanger for heating water while the water passes through a heat exchange pipe.
